(19) United States
(12) Patent Application Publication
(10) Pub. No.: US 2008/0227485 A1
(43) Pub. Date: Sep. 18, 2008

(54) APPARATUS AND METHOD FOR TRANSCEIVING IN PORTABLE COMMUNICATION SYSTEM

(76) Inventor: Hak-Joon KIM, Seoul (KR)

Correspondence Address: CHA & REITER, LLC, 210 ROUTE 4 EAST STE 103, PARAMUS, NJ, 07652, US

(21) Appl. No.: 12/014,870

(22) Filed: Jan. 16, 2008

(30) Foreign Application Priority Data
Mar. 13, 2007 (KR) 2007-0024296

(51) Int. Cl. H04Q 7/20

(52) U.S. Cl. 455/552.1

(57) ABSTRACT

Disclosed is an apparatus and method for transceiving in a multi mode portable communication system. The apparatus includes a first antenna, a second antenna, a first switch, and a communication unit. The first antenna is capable of transceiving a signal of a first communication mode. The second antenna is capable of transceiving a signal of a second communication mode. The first switch connects with a first communication mode transceiver or a second communication mode transceiver. The communication unit connects the first switch and a second switch with the first communication mode transceiver.

### CLAIM OF PRIORITY

This application claims the benefit of the earlier filing date, under 35 U.S.C. §119(a), to that patent application filed in the Korean Intellectual Property Office on Mar. 13, 2007 and assigned Serial No. 2007-0024296, the contents of which are incorporated herein by reference.

### BACKGROUND OF THE INVENTION

1. Field of the Invention

The present invention relates to a multi mode portable communication system, and in particular, to an apparatus and method for enhancing reception efficiency by the realization of a diversity antenna in one multi mode portable communication system.

2. Description of the Related Art

European mobile communication systems adopting Global System for Mobile (GSM) communication, a kind of Time Division Multiple Access (TDMA), use a radio frequency band of 900 MHz and a radio frequency band of 1.8 GHz.

UMTS (Universal Mobile Telecommunication System) adopting Wideband-CDMA (W-CDMA) or CDMA is the same in general concept as IMT-2000 that is a next-generation mobile communication system of Korea. This system transmits data at a rate of 2 Mbps (mega bits per second) using a radio frequency band of 2.1 GHz.

Portable communication systems supporting both GSM and UMTS are referred to as multi mode portable communication systems. Multi mode portable communication systems include antennas corresponding to the different mobile communication systems (e.g., GSM and UMTS) to support the mobile communication systems.

FIG. 1 illustrates a construction of an antenna of a conventional multi mode portable communication system.

Referring to FIG. 1, the multi mode portable communication system can include a first antenna 100, a first transceiver 102, a first modem 104, a second antenna 110, a second transceiver 112, and a second modem 114.

Upon receipt of a receivable radio signal from a mobile communication system through the first antenna 100, the first transceiver 102 forwards the received signal to the first modem 104.

Alternatively, upon receipt of a receivable radio signal from a mobile communication system through the second antenna 110, the second transceiver 112 forwards the received signal to the second modem 114.

In call processing, the portable communication system supports one communication mode during the call and keeps the other communication mode in an idle state.

For example, when the portable communication system is in a CDMA mode, it keeps a GSM mode management unit in an idle state, on the assumption that the portable communication system is a multi mode portable communication system supporting both the CDMA mode and a GSM mode.

### SUMMARY OF THE INVENTION

An aspect of the present invention is to provide an apparatus and method for enhancing antenna efficiency in a multi mode portable communication system.

Another aspect of the present invention is to provide an apparatus and method for realizing a diversity antenna in a multi mode portable communication system.

The above aspects are achieved by providing an apparatus and method for transceiving in a portable communication system.

According to one aspect of the present invention, there is provided an apparatus for transceiving in a multi mode portable communication system supporting at least two mobile communication systems. The apparatus includes a first antenna, a second antenna, a first switch, and a communication unit. The first antenna is capable of transceiving (transmitting/receiving) a signal of a first communication mode. The second antenna is capable of transceiving a signal of a second communication mode. The first switch has a connection with the first antenna, and connects with a first communication mode transceiver in the first communication mode and connects with a second communication mode transceiver in the second communication mode. The communication unit in the first communication mode connects the first switch and a second switch with the first communication mode transceiver, and receives a radio signal of the first communication mode through the first antenna and receives a diversity signal through the second antenna.

According to another aspect of the present invention, there is provided a method for transceiving in a multi mode portable communication system supporting at least two mobile communication systems. The method includes, in a first communication mode, setting a first path to receive a radio signal of the first communication mode through a first antenna and receive a diversity signal through a second antenna; and in a second communication mode, setting a second path to receive a radio signal of the second communication mode through the second antenna and receive a diversity signal through the first antenna.

### BRIEF DESCRIPTION OF THE DRAWINGS

The above features and advantages of the present invention will become apparent from the following detailed description when taken in conjunction with the accompanying drawings in which:

FIG. 1 is a block diagram illustrating a construction of an antenna of a conventional multi mode portable communication system;

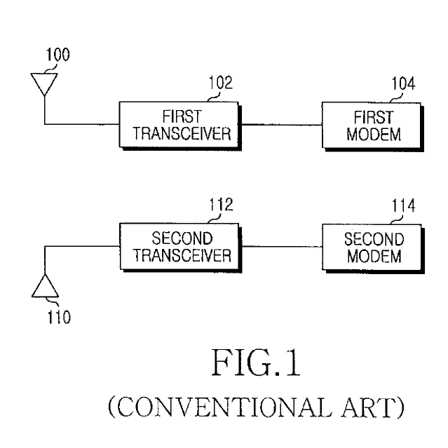

FIG. 2 is a block diagram illustrating a construction of a multi mode portable communication system with a diversity antenna according to an exemplary embodiment of the present invention;

FIG. 3 is a flowchart illustrating a procedure of enhancing reception efficiency by a diversity antenna in a multi mode portable communication system according to an exemplary embodiment of the present invention; and

FIGS. 4A and 4B are block diagrams illustrating a communication unit of a multi mode portable communication system operating in response to a received radio signal of a mobile communication system according to an exemplary embodiment of the present invention.

### DETAILED DESCRIPTION OF THE INVENTION

Embodiments of the present invention will be described with reference to the accompanying drawings. For the purposes of clarity and simplicity, well-known functions or constructions are not described in detail as they may obscure the invention in unnecessary detail. The terms described below, terms defined considering their functions in the present invention, can be different depending on a user or operator's intention or a practice. Thus, the definition should be made on the basis of the contents throughout this specification.

An apparatus and method for realizing a diversity antenna to enhance antenna efficiency in a multi mode portable communication system will be described below. In the definitions described below, a first communication mode is one of two communication modes supported in the portable communication system and the second communication mode is a communication mode besides the first communication mode.

The second communication mode can be a second-generation communication mode if the first communication mode is defined as a third-generation communication mode. The second communication mode also can be a third-generation communication mode if the first communication mode is defined as a second-generation communication mode.

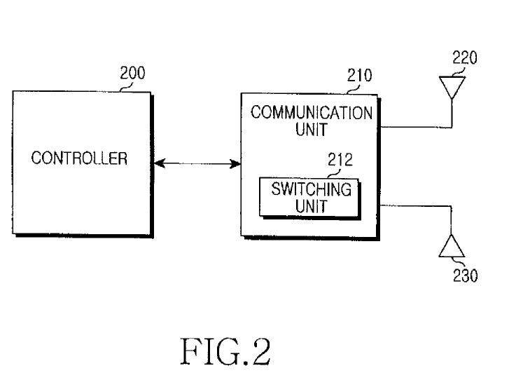

FIG. 2 is a block diagram illustrating a construction of a multi mode portable communication system with a diversity antenna according to an exemplary embodiment of the present invention.

Referring to FIG. 2, the portable communication system can include a controller 200, a communication unit 210, a first antenna 220, and a second antenna 230.

The diversity antenna is an antenna receiving the same signal which is being received on another antenna which is operating in such as well-known multiple antenna communication system

The controller 200 controls a general operation of the mobile communication system. For example, the controller 200 performs a process and a control for voice communication and data communication. In addition to a general function, the controller 200 controls the communication unit 210 to set a path of a switching unit 212 corresponding to a communication mode executed in the portable communication system according to the present invention.

In other words, the controller 200 controls the communication unit 210 to set the switching unit 212 to a path adapted for first communication mode execution when the portable communication system identifies that it receives a signal through the first antenna 220 supporting a first communication mode.

The controller 200 controls the communication unit 210 to set the switching unit 212 to a path adapted for second communication mode execution if the portable communication system identifies that it receives a signal supporting a second communication mode through the second antenna 230.

The path adapted for the first communication mode execution refers to a path for allowing reception of a signal supporting the first communication mode through the first antenna 220 and reception of a diversity signal through the second antenna 230.

Also, the path adapted for the second communication mode execution refers to a path for allowing reception of a signal supporting the second communication mode through the second antenna 230 and reception of a diversity signal through the first antenna 220.

The communication unit 210 includes a first modem for first communication mode and a second modem for second communication mode. The communication unit 210 performs a function of transceiving and processing a radio signal of data inputted/outputted through the first and second antennas 220 and 230.

For example, in transmission mode, the communication unit 210 processes data by channel coding, spreading, and Radio Frequency (RF) conversion and transmits the processed data. In reception mode, the communication unit 210 converts a received RF signal into a baseband signal and processes the baseband signal by de-spreading and channel decoding for data restoration. The communication unit 210 instructs the switching unit 212 to set a communication path corresponding to a communication mode of the portable communication system under the control of the controller 100 according to the present invention.

The switching unit 212 sets the communication path adapted for the first communication mode execution under the instruction of the communication unit 210 when the portable communication system identifies that it receives a signal from a mobile communication system supporting a first communication mode through the first antenna 220.

The switching unit 212 sets the path adapted for the second communication mode execution when the portable communication system identifies that it receives a signal from a mobile communication system supporting a second communication mode through the second antenna 230.

In other words, the switching unit 212 connects a first switch having connection with the first antenna 220 and a second switch having connection with the second antenna 230 with a first transceiver when setting the communication path adapted for the first mode execution.

The switching unit 212 connects the first switch having connection with the first antenna 220 and the second switch having connection with the second antenna 230 with a second transceiver when setting the communication path adapted for the second mode execution.

The communication unit 210 can perform functions of the switching unit 212. However, these are separately constructed and shown in order to distinguish and describe respective functions in the present invention. Thus, when a product is actually realized, the product can also be constructed for the communication unit 210 to process all of the respective functions.

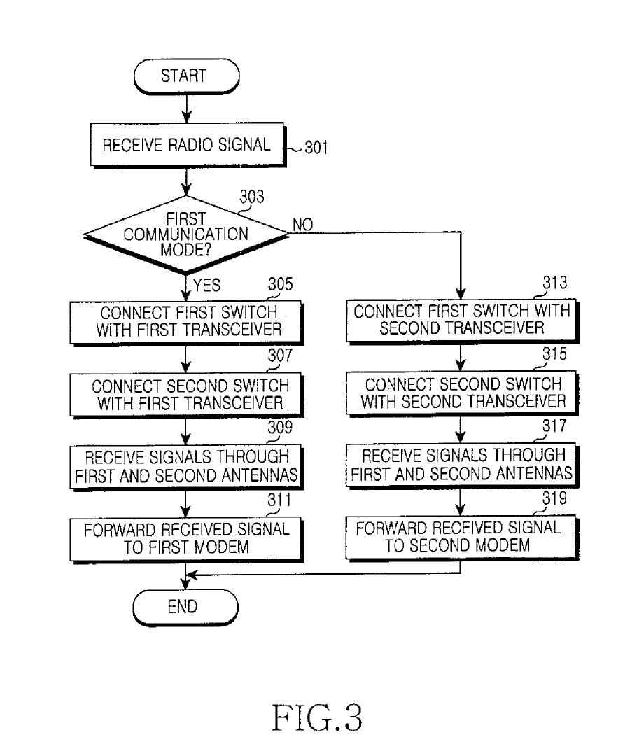

The above description has been made for an apparatus for enhancing antenna efficiency in a multi mode portable communication system. A method for enhancing the antenna efficiency in the multi mode portable communication system using the apparatus is described below. FIG. 3 is a flowchart illustrating a procedure of enhancing reception efficiency by a diversity antenna in a multi mode portable communication system according to an exemplary embodiment of the present invention.

Referring to FIG. 3, a controller 200 of the portable communication system receives a radio signal in Step 300. Here, the controller 200 can receive a radio signal by an antenna corresponding to the radio signal. For example, assuming that a CDMA communication mode is a first communication mode, when receiving a CDMA signal that is a radio signal of the first communication mode, the controller 200 can provide a control such that the CDMA signal is received through a first antenna 220. When receiving a radio signal of a second communication mode (e.g., GSM signal), the controller 200 can provide a control such that the radio signal of the second communication mode is received through a second antenna 230.

In Step 303, the controller 200 checks whether a received radio signal is a radio signal (e.g., a CDMA signal) of the first communication mode. The controller 200 controls the communication unit 210 to set a communication path corresponding to the first communication mode in Step 305 if the received radio signal is the radio signal of the first communication mode.

Under the control of the controller 200, the communication unit 210 processes and connects a first switch having connection with the first antenna 220 with a first transceiver.

In Step 307, the controller 200 controls the communication unit 210 to connect a second switch having connection with the second antenna 230 with the first transceiver, receiving the radio signal through the first antenna 220 and enhancing reception efficiency of the radio signal by a diversity signal through the second antenna 230.

The controller 200 receives the radio signal through the first antenna 220 and receives the diversity signal through the second antenna 230 in Step 309, and forwards the received radio signal and diversity signal to a first modem (e.g., a CDMA modem) in Step 311.

If the received radio signal is a radio signal (e.g., a GSM signal) of the second communication mode, the controller 200 controls the communication unit 210 to set a communication path corresponding to the second communication mode in Step 313.

Under the control of the controller 200, the communication unit 210 processes and connects a second switch having connection with the second antenna 230 with a second transceiver

In Step 315, the controller 200 controls the communication unit 210 to connect a first switch having connection with the second antenna 230 with a second transceiver, receiving the radio signal through the second antenna 230 and enhancing reception efficiency of the radio signal by a diversity signal through the first antenna 220.

The controller 200 receives the radio signal through the second antenna 230 and receives the diversity signal through the first antenna 220 in Step 317, and forwards the received radio signal and diversity signal to a second modem (e.g., a GSM modem) in Step 319.

The controller 200 next terminates the described algorithm.

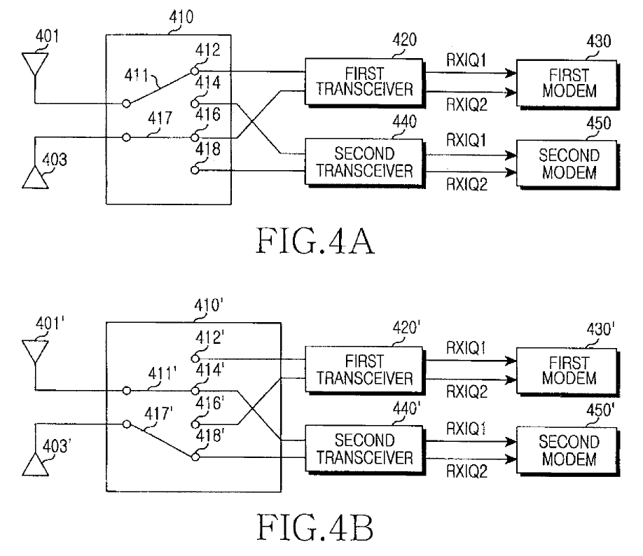

FIGS. 4A and 4B are block diagrams illustrating a communication unit of a multi mode portable communication system that operates depending on a type of a received radio signal according to an exemplary embodiment of the present invention.

FIG. 4A shows the communication unit of the portable communication system that operates in a first communication mode.

How to identify whether a radio signal is communicated in a first communication mode or a second communication mode is a well known technology. FIG. 4A is about the first communication mode.

Referring to FIG. 4A, assuming that the communication unit of the portable communication system receives a radio signal through a first antenna 401, the communication unit processes and connects a first switch 411 having connection with the first antenna 401 and a second switch 417 having connection with a second antenna 403 with a first transceiver 420 at switching points 412 and 416, respectively.

The first switch 411 connects with the first transceiver 420 at the switching point 412 to receive a radio signal (RXIQ1) through the first antenna 401. The second switch 417 connects with the first transceiver 420 at the switching point 416 to receive a diversity signal (RXIQ2) through the second antenna 403.

The diversity signal is the same signal received on the first antenna 401. The mechanism of the same multiple signal process in a transceiver such as a mobile communication terminal and performance improvements thereof are known to the telecommunication technology field as multi antenna communication system.

The first switch 411 can connect with a second transceiver 440 at a switching point 414 and receive a diversity signal in a case where the portable communication system receives a radio signal through the second antenna 403.

In a case where the first switch 411 and the second switch 417 connect with the first transceiver 420 at the switching points 412 and 416, the communication unit processes and forwards a radio signal (RXIQ1) and a diversity signal (RXIQ2) received through the first antenna 401 and the second antenna 403, respectively, to a first modem 430. The communication unit 210 via controlling by the controller 200 controls the first switch 411 and the second switch 417 to connect with the transceivers 420, 440. Or the controller 200 itself can control the first switch 411 and the second switch 417 to connect with the transceivers 420, 440. For example, when a call is received, the controller 200 informs the user of the receipt of the call. If the user responds to the received call, the controller 200 controls the first switch 411 and the second switch 417 to connect with the transceivers 420, 440.

FIG. 4B shows a communication unit of the portable communication system that operates in a second communication mode.

How to identify whether a radio signal is communicated in a first communication mode or a second communication mode is a well known technology. FIG. 4A is about the second communication mode.

Referring to FIG. 4B, assuming that the communication unit of the portable communication system receives a radio signal through a second antenna 403′, the communication unit processes and connects a first switch 411′ having connection with the first antenna 401′ and a second switch 417′ having connection with a second antenna 403′ with a second transceiver 440′ at switching points 414′ and 418′, respectively The second switch 417′ connects with the second transceiver 440′ at the switching point 414′ to receive a radio signal (RXIQ2) through the second antenna 403′. The first switch 411′ connects with the second transceiver 440′ at the switching point 418′ to receive a diversity signal (RXIQ1) through the first antenna 401′.

The second switch 417′ can connect with a first transceiver 420′ at a switching point 416′ and receive a diversity signal in a case where the portable communication system receives a radio signal through the first antenna 401′.

The communication unit processes and forwards a radio signal (RXIQ2) and a diversity signal (RXIQ1) received through the first antenna 401′ and the second antenna 403′ to a second modem 450′ in a case where the first switch 411′ and the second switch 417′ connect with the second transceiver 440′ at the switching points 418′ and 414′.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

The above description has been made for an apparatus and method for enhancing antenna efficiency by, upon call connection, receiving a radio signal by one antenna and receiving a diversity signal by the other antenna in a multi mode portable communication system. The portable communication system processes and operates like a given multi mode portable communication system when not performing a call connection procedure.

As described above, the present invention can provide enhanced antenna efficiency in a multi mode portable communication system with antennas configured to receive a radio signal for call processing via one antenna and receive a diversity signal via the other antenna.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An apparatus for transceiving in a multi mode portable communication system supporting at least two mobile communication systems, the apparatus comprising:
a first antenna capable of transceiving a signal of a first communication mode;
a second antenna capable of transceiving a signal of a second communication mode;
a first switch having connection with the first antenna, and connecting with a first communication mode transceiver in the first communication mode and connecting with a second communication mode transceiver in the second communication mode;
a second switch having connection with the second antenna, and connecting with the first communication mode transceiver in the first communication mode and connecting with the second communication mode transceiver in the second communication mode. and
a communication unit for determining reception of a signal in the first communication mode, and connecting the first switch and the second switch with the first communication mode transceiver where in said signal of the first communication mode is received through the first antenna and a diversity signal is received through the second antenna.

2. The apparatus of claim 1, wherein in the second communication mode, the communication unit connects the first switch and the second switch with the second transceiver, and receives a diversity signal through the first antenna and receives a radio signal of the second communication mode through the second antenna.

3. The apparatus of claim 2, wherein the first communication mode is a third-generation communication mode and the second communication mode is a second-generation communication mode.

4. A method operable in a computer system for transceiving in a multi mode portable communication system supporting at least two mobile communication systems, the method comprising;
in a first communication mode, setting a first path to receive a radio signal of the first communication mode through a first antenna and receive a diversity signal through a second antenna; and
in a second communication mode, setting a second path to receive a radio signal of the second communication mode through the second antenna and receive a diversity signal through the first antenna.

5. The method of claim 4, further comprising:
in the first communication mode, forwarding a signal received through the first path to a first communication mode transceiver; and
in the second communication mode, forwarding a signal received through the second path to a second communication mode transceiver.

6. The method of claim 4, wherein the setting of the first path further comprises:
connecting a first switch having connection with the first antenna with the first communication mode transceiver; and
connecting a second switch having connection with the second antenna with the first communication mode transceiver.

7. The method of claim 4, wherein the setting of the second path further comprises:
connecting the second switch having connection with the second antenna with the second communication mode transceiver; and
connecting the first switch having connection with the first antenna with the second communication mode transceiver.

8. The method of claim 4, wherein the first communication mode is a third-generation communication mode and the second communication mode is a second-generation communication mode.

9. A device for controlling a processing configuration of a multi mode portable communication system supporting at least two mobile communication systems, the device comprising:
a processor in communication with a memory, the processor accessing code in the memory for:
setting a first path to receive a radio signal of a first communication mode through a first antenna and receive a diversity signal through a second antenna in a first communication mode; and
setting a second path to receive a radio signal of the second communication mode through the second antenna and receive a diversity signal through the first antenna in a second communication mode.

10. The device of claim 9, wherein said first path forwards a signal received to a first communication mode transceiver and the second path forwards a signal received through the second path to a second communication mode transceiver.

11. The device of claim 10, wherein the setting of the first path comprises:
connecting a first switch having connection with the first antenna with the first communication mode transceiver; and
connecting a second switch having connection with the second antenna with the first communication mode transceiver.

12. The device of claim 10, wherein the setting of the second path comprises:
connecting a second switch having connection with the second antenna with the second communication mode transceiver; and
connecting a first switch having connection with the first antenna with the second communication mode transceiver.

13. The device of claim 9, wherein the first communication mode is a third-generation communication mode and the second communication mode is a second-generation communication mode.

14. An apparatus for transceiving in a multi mode portable communication system, the apparatus comprising:
a first antenna capable of transceiving a signal of a first communication mode;
a second antenna capable of transceiving a signal of a second communication mode; and
a first switch having connection with the first antenna, and connecting with a first communication mode transceiver in the first communication mode and connecting with a second communication mode transceiver in the second communication mode.
a controller for determining reception of a signal in the first communication mode, and connecting the first switch and the second switch with the first communication mode transceiver, wherein said signal of the first communication mode is received through the first antenna and a diversity signal is received through the second antenna.

15. The apparatus of claim 14, further comprising a second switch having connection with the second antenna, and connecting with the first communication mode transceiver in the first communication mode and connecting with the second communication mode transceiver in the second communication mode.

16. The apparatus of claim 15, wherein in the second communication mode, the controller connects the first switch and the second switch with the second transceiver, and receives the diversity signal through the first antenna and receives a radio signal of the second communication mode through the second antenna.

17. The apparatus of claim 16, wherein the first communication mode is a third-generation communication mode and the second communication mode is a second-generation communication mode.

18. A method operable in a computer system for transceiving in a multi mode portable communication system, the method comprising:
setting a first path to receive a radio signal of a first communication mode through a first antenna and receive a diversity signal through a second antenna.

19. The method of claim 18, further comprising the step of setting a second path to receive a radio signal of the second communication mode through the second antenna and receive the diversity signal through the first antenna.
